(19) United States
(12) Patent Application Publication
(10) Pub. No.: US 2025/0262935 A1
(43) Pub. Date: Aug. 21, 2025

(54) DISPLAY SYSTEM

(71) Applicant: AUDI AG, Ingolstadt (DE)

(72) Inventors: Rebekka NEUMANN, Gaimersheim-Lippertshofen (DE); Sebastien AMBROSETTI, Waidhofen (DE)

(73) Assignee: AUDI AG, Ingolstadt (DE)

(21) Appl. No.: 19/053,684

(22) Filed: Feb. 14, 2025

(30) Foreign Application Priority Data
Feb. 15, 2024 (DE) 10 2024 104 193.5

(51) Int. Cl. B60K 35/22; B60K 35/60

(52) U.S. Cl. CPC B60K 35/22; B60K 35/60; B60K 2360/175; B60K 2360/177; B60K 2360/21; B60K 2360/338; B60K 2360/785

(57) ABSTRACT

A display system for at least one pane of a window of an interior of a vehicle. The display system comprises light elements arrangeable on the at least one pane, at least one control device, and at least one sensor to detect at least one object in surroundings of the vehicle. The at least one control device is designed to activate at least one light element on the at least one pane, which from a perspective of an observer from the interior through the at least one pane, is assigned to the at least one object that is detected in the surroundings, wherein the at least one light element activated is designed to mark the at least one object.

### CROSS REFERENCE TO RELATED APPLICATIONS

This application is based upon and claims the priority benefit of German Application No. 10 2024 104 193.5 filed on Feb. 15, 2024, the entire contents of which are incorporated by reference herein.

### BACKGROUND

### 1. Field

The described examples relate to a display system and a method for operating a display system.

### 2. Description of the Related Art

A display device for a vehicle, which is integrated in a windshield, is discussed in document US 2021/063738 A1.

A glazing of a windshield of a vehicle having an integrated light signaling function is described in document DE 20 2015 009 229 U1.

### SUMMARY

Against this background, examples display the surroundings of a vehicle to an occupant of the vehicle in a suitable manner.

The examples may be achieved by a display system and a method having the features of the independent claims. Embodiments of the display system and the method are disclosed in the dependent claims and the description.

The display system according to an example, may be designed for at least one pane of a window of a vehicle, for example, of an ego vehicle, which typically delimits and/or terminates an interior of the vehicle to the outside. The display system may comprise light elements or light sources, which are typically arranged regularly and/or uniformly distributed on the at least one pane or a respective pane and which cover the at least one or the respective pane, typically completely and/or comprehensively. In addition, the display system may comprise at least one control device and at least one sensor for detecting the surroundings outside the vehicle. The at least one sensor, e.g., a camera, a radar sensor, a lidar sensor, or an ultrasonic sensor, is designed here to detect at least one object in the surroundings of the vehicle. The at least one control device, which can be designed and/or referred to as a computing unit, is designed to activate at least one light element on the at least one pane, which is assigned, originating from a perspective of an observer in the interior from the interior through the at least one pane, to the at least one detected object in the surroundings. The at least one activated light element is designed to mark the at least one object, generally originating from the perspective of the observer, by at least one marking and/or as at least one marking which is or will be assigned to this object.

The light elements are typically arranged in at least one strip on the at least one pane, which completely covers the respective pane in one embodiment. Such a strip is transparent in each case here and comprises a plurality of regularly and/or uniformly distributed light elements. The at least one strip is in one embodiment fastened, for example, adhesively bonded, on an inner side of the respective pane facing toward the interior. In general, the display system comprises multiple such strips, which are arranged oriented parallel to one another, for example, horizontally, possibly only horizontally, and/or vertically, possibly only vertically, on the at least one pane and flush with one another. The strips can be arranged, for example, as a matrix pattern and/or in a matrix pattern. However, it is also possible that all light elements are arranged in only one strip, which can completely cover the respective pane. The light elements are in one embodiment arranged in a field made up of lines and columns on the at least one pane. The light elements can be arranged in a uniform density on the at least one pane, wherein the respective pane can be utilized comprehensively in this case.

The light elements, which are digital in one embodiment, are typically designed as light-emitting diodes (LEDs), for example, as organic light-emitting diodes (OLEDs) or as micro light-emitting diodes (μLEDs), and are colored when they are activated. If they are deactivated, they are transparent. Each such light-emitting diode has a maximum size or dimension, thus length, width, and/or height of 1 mm.

In one embodiment, it is provided that the at least one control device exchanges data with at least one driver assistance system of the vehicle. The at least one driver assistance system, which can also be designed as a component of the display system, is designed to assist a driver as an occupant of the vehicle and typically to supervise a journey of the vehicle, depending on the currently set level of automation of the vehicle, for example, to control and/or regulate it. This is possible, for example, for a level 2, level 3, level 4, or level 5. These mentioned levels 2 to 5 designate assisted driving, semiautomated driving, highly automated driving, fully automated driving, or autonomous driving of the vehicle, wherein a respective assisted and/or at least partially automated driving corresponds to a respective level.

In addition, the at least one driver assistance system is designed to sensorially detect, recognize, and/or determine the at least one object to be marked from multiple objects in the surroundings. Images of the surroundings are provided to the at least one driver assistance system by the at least one sensor, e.g., a camera, a radar sensor, or another sensor for detecting the surroundings, for the surroundings, which images are evaluated by the at least one driver assistance system, wherein objects to be marked from the surroundings are also identified by the at least one driver assistance system. The display system generally has multiple driver assistance systems as components, multiple sensors for detecting the surroundings, and multiple control devices.

The at least one driver assistance system can perform an evaluation based on data which are detected by the sensors and can react accordingly to changes in the surroundings, for example, movements of other road users, for example, of external vehicles. In addition, traffic signs can be detected and marked, in particular if they display a speed limit, for example, of 50 km/h. A marking can have at least one specific color and can be static or dynamic, for example, can flash, for example, to indicate that a set speed of the ego vehicle will be automatically adapted and it automatically regulates down its speed. In addition, it is possible that objects in the surroundings were or have been already recognized, although they are not yet visible in the field of view through the windshield. These objects can be indicated beforehand by markings at the edge of the pane, for example, traffic signs at the upper edge.

The display system is generally intended and/or to be used for a pane of a front window of the vehicle designed as a windshield or front window. However, it can also be intended and/or to be used for another pane of a window of the vehicle, for example, a side pane for a side window or a rear pane for a rear window, of the vehicle. An object which comes from the rear or drives next to the vehicle and approaches the vehicle while reducing a relative distance can also be marked here on the side pane or rear pane, for example, as soon as the distance falls below a limiting value provided for this purpose and the object is located in a field of view.

Furthermore, the display system can comprise at least one sensor, for example, a camera, for detecting the interior of the vehicle, which is designed to detect a head and/or a viewing direction of eyes of the occupant as an observer in the interior of the vehicle through the at least one pane into the surroundings. On the basis of the head or its position in the interior and/or the viewing direction of the eyes, the perspective and/or a field of view of the observer from the interior through the at least one pane into the surroundings is determined. Furthermore, the at least one light element to be activated is and/or will be determined here, which is and/or will be assigned to the at least one detected object in the surroundings originating from the perspective of the observer.

The method according to examples is intended for operating a display system, for example, an embodiment of the display system presented above, for at least one pane of a window of an interior of a vehicle, for example, a motor vehicle. The display system comprises light elements, which are arranged on the at least one pane, at least one control device, and at least one sensor for detecting the surroundings or an environment of the vehicle. At least one object in the surroundings of the vehicle is detected using the at least one sensor. At least one light element is deliberately activated on the at least one pane and, for example, set in color by the at least one control device, which light element is assigned originating from a perspective of an observer from the interior through the at least one pane to the at least one detected object in the surroundings. All other light elements arranged on the at least one pane are or remain deactivated. In addition, the at least one object is marked by the at least one activated light element.

A respective activated light element is colored in one embodiment using a color selected for this purpose, wherein the respective color light element is or remains transparent for the surroundings and the object to be marked. In one embodiment, it is checked by at least one driver assistance system which at least one detected object in the surroundings is relevant for a, typically current, journey and/or driving situation of the vehicle. Among a number of sensorially detected objects in the surroundings, the at least one object which is relevant for the driving situation is selected here by the at least one driver assistance system. This at least one object which is relevant and/or classified as relevant by the driver assistance system is marked, typically in consideration of the determined perspective of the observer, by the at least one driver assistance system, which exchanges data with the at least one control device, by the at least one light element, which is actuated and activated by the at least one driver assistance system and/or by the at least one control device, for example, digitally, wherein a respective color is also selected and set depending on a relevance of the object.

It is provided that at least one road user, typically a further external vehicle, for example, an external vehicle, a pedestrian, a typically stationary device, for example, a building, a plant, for example, a tree, and/or a road sign, for example, a traffic sign, or a light system, typically a traffic signal, is marked as the at least one object using at least one color. A respective object detected and/or recorded by the at least one sensor, thus only one sensor or multiple sensors, for the surroundings is automatically recognized by the at least one driver assistance system (DAS) and its relevance is determined for the respective journey and/or driving situation.

A relevance of a recognized or identified object can be automatically determined by the at least one driver assistance system depending on at least one kinematic parameter of the object, for example, a position, a speed, and/or an acceleration of the object relative to the ego vehicle. It can be distinguished here whether an object is located on a road or roadway traveled by the vehicle or adjacent thereto, for example, on an oncoming roadway or a side road. It can also be determined whether an object is located on a planned trajectory of the ego vehicle. The object is all the more relevant here the smaller its distance to the ego vehicle is. In addition, it is more relevant if the distance between the moving object and the moving ego vehicle is decreasing, whereas it is less relevant if the distance is increasing.

In one embodiment, a symbol, which is assigned to the at least one object for its marking, is generated by the at least one activated light element. A type of a respective symbol and/or its respective set color can depend on a relevance, a status, and/or a movement of the respective object to be marked. A particularly relevant object can thus be assigned a marking and/or a symbol having a so-called warning color as the color, for example, red or yellow, using which a warning is made about this particularly relevant object. A less relevant object can only be assigned a so-called notification color as the color, for example, green or blue. It is possible in one embodiment that a spectrum is provided and/or defined for colors, for example, individually by a driver of the vehicle, wherein each color is assigned a specific relevance or a specific status. It is also possible that a respective marking is static or dynamic and in the latter case it flashes and/or comprises an animation for marking an object. The status and/or the relevance of the object can be depicted using a respective color. A respective color can be assigned in each case to a definable limiting value of a respective kinematic parameter.

In one possible embodiment, at least one line of sight of the driver to the at least one object in the surroundings is determined originating from a head of an occupant, for example, the driver, in the interior, which is detected by the at least one sensor for the interior. In addition, at least one intersection point of the at least one line of sight with the at least one pane is determined, for example, calculated, typically by the at least one control device, wherein at least one light element is activated on the at least one intersection point or a position determined for this purpose on the at least one pane and the object is marked.

An augmented windshield marking of objects can be provided on and/or in the windshield using the display system and the method using digital light-emitting diodes as the light elements. A corresponding augmented windshield comprises the light elements, which are typically programmable, arranged as lines in rows and/or columns. Each light element, designed as a light-emitting diode, for example, can be actuated via transparent electrodes, via which it is connected to the at least one control device.

It is possible that multiple directly adjacent light elements along a respective horizontal or vertical line are connected to one another via thin and/or fine lines, for example, wires. A resulting vision restriction in the surroundings is comparable to a vision restriction due to fine wires of a heatable windshield and is therefore negligible.

The method can be carried out by way of example for a level 2 situation or a level 3 situation as an at least semiautomated driving situation or a completely automated driving situation of the ego vehicle. The vehicle or its respective driving situation is supervised, thus controlled and/or regulated, by the at least one driver assistance system or assisted with its aid (level 1 or level 2) and/or at least partially automatically or autonomously (level 3, level 4, or level 5). The at least one driver assistance system automatically reacts here to objects in the surroundings, maintains distance thereto automatically, automatically maintains a speed specified for the road traveled, and/or reacts automatically to changes of external conditions or of conditions in the surroundings, thus to an arrangement of the objects in the surroundings, which typically changes dynamically relative to the ego vehicle. These objects can be detected and marked, for example, depending on their relevance, in the at least one augmented pane, for example, the windshield. The driver, who still has driving responsibility, can thus detect more quickly, among other things, whether the externally located objects were and/or are correctly recognized and the vehicle reacts, is controlled, and/or is regulated correctly for the situation.

In the method, at least one marking is respectively assigned to an object to be marked originating from the perspective of the observer, wherein the real object or the object directly visible through the at least one pane is marked, for example, overlaid and/or superimposed, with the at least one marking assigned thereto on the at least one pane. If an object is marked by multiple activated light elements or by multiple markings, the markings can form an area. A position of a real object in the surroundings is compared to a position of the at least one marking intended for it on the windshield by the at least one control device and/or the at least one driver assistance system, wherein the position of the at least one marking on the at least one pane can be geometrically correlated with the position of the marking on the at least one pane, according to the above-described intersection point. The markings on the at least one pane are directly linked here to the surroundings or an outside world and the objects located at different positions therein, wherein at least one marking is directly assigned to an object in each case.

In this way, a complexity of a display, a time expenditure, and a cognitive load for the comparison of objects by the driver can be massively reduced. Furthermore, a distraction potential of the driver, among other things, by looking away, is also reduced. In one embodiment, the pane, designed as the windshield, for example, is used as an information display for the driver and/or for the at least one driver assistance system. In the method, sensors present on and/or in the vehicle in any case can be used to detect the surroundings and/or the interior. The sensorially detected surroundings or an image thereof are or is evaluated by the at least one control device and/or the at least one driver assistance system, typically for the presence of relevant objects.

A respective provided marking as information is based on the at least one driver assistance system and/or relates thereto, wherein feedback of the at least one driver assistance system, which is essential for the driver, is represented via the markings. Using the display system and the method, markings of objects and their associated statuses can be displayed in an augmented manner over the entire surface of the windshield. Different objects distributed in the surroundings can be optically highlighted via the markings represented by the light elements, which are distributed on the windshield. If the display system or the method is used for a side pane or the rear pane, objects which are located on an adjacent lane or behind the vehicle and therefore 360° around the vehicle and/or which have a greater distance to the vehicle can also be represented.

It is obvious that the above-mentioned features and the features still to be explained hereinafter are usable not only in the respective specified combination, but also in other combinations or alone, without departing from the scope of the present invention.

### BRIEF DESCRIPTION OF THE DRAWINGS

The invention is schematically illustrated in the drawing on the basis of embodiments and will be described schematically and in detail with reference to the drawing. These and other aspects and advantages will become more apparent and more readily appreciated from the following description of the examples, taken in conjunction with the accompanying drawings of which:

FIGS. 1a, 1b (1a and 1b) show a schematic representation of a display system according to examples carrying out the method.

### DETAILED DESCRIPTION

Reference will now be made in detail to examples illustrated in the accompanying drawings, wherein like reference numerals refer to like elements throughout. The examples described below are examples of the invention. In the examples, the described components each may represent individual features that should be considered independently of one another and which also develop the examples in each case independently of one another. Therefore, the disclosure is also intended to comprise combinations of the features of the examples other than those illustrated. Furthermore, the described examples can also be supplemented with further features of the examples that have already been described.

The figures are described in a connected and comprehensive manner. Identical reference signs are assigned to the same components.

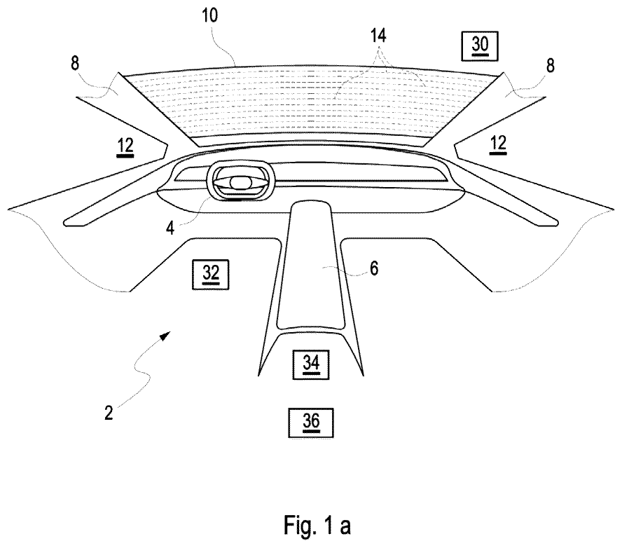

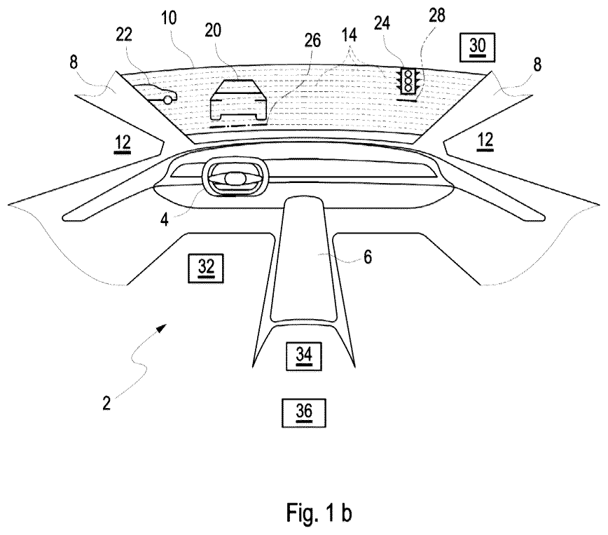

FIGS. 1a and 1b (1a and 1b) show an interior 2 of a vehicle, designed here as a motor vehicle, which is furthermore also designated as an ego vehicle. Among other things, a steering wheel 4 and a center console 6, but also seats (not shown in more detail) for occupants of the vehicle, thus a driver seat for a driver, who steers the vehicle using the steering wheel 4, and a front passenger seat for a front passenger, are provided in the interior 2. The vehicle comprises two A-pillars 8 as supports, between which a pane designed as a windshield 10 is arranged. FIGS. 1a and 1b also show two panes designed as side panes 12, which are arranged on the left and right on longitudinal sides of the vehicle.

The display system according to an example comprises multiple transparent strips 14 having light-emitting diodes as light elements, wherein the light-emitting diodes are uniformly distributed on each strip 14. These strips 14 are arranged horizontally one over another on the inner side of the windshield 10 and completely and/or comprehensively cover the windshield 10. The light-emitting diodes in the strips 14 are distributed with or in a regular density completely and/or comprehensively on the windshield 10, for example, wherein each light element is arranged between multiple directly adjacent light elements and has the same distance from each directly adjacent light element.

In an example, it is possible that strips 14 having light-emitting diodes are also arranged on inner sides of the side panes 12 or a rear pane. The display system additionally comprises at least one first sensor 30, for example, a camera or a radar sensor, for detecting the surroundings of the vehicle outside the interior 2, a second sensor 32, a camera here, for detecting the interior 2, and a control device 34.

FIGS. 1a and 1b also show a driver assistance system 36 of the vehicle, which is designed to assist the driver during a manual journey, completely controlled by the driver, or during an at least semiautomatic journey, in which the driver partially manually controls the vehicle, on the one hand, wherein the vehicle is at least partially, possibly completely automatically controlled by the driver assistance system 36, on the other hand. The driver assistance system 36 is also designed here to at least partially, possibly completely automatically control the vehicle. In the embodiment presented here, the driver assistance system 36 is also designed as a component of the embodiment of the display system presented here.

In the method of operating the display system, for example, the surroundings and objects located therein, in this case two vehicles as road users of the ego vehicle, which are designed or are to be designated here as external vehicles 20, 22, and a traffic signal as a road sign 24 are detected by the at least one first sensor 30 for the surroundings. These real objects in the surroundings can furthermore also be seen by the driver as an observer originating from his perspective on the driver seat in the interior through each pane, thus through the windshield 10, but also through each side pane 12. A position of a head of at least one occupant, in general the driver, and/or his perspective, his field of view, and/or his view outward into the surroundings is/are detected by the camera as the second sensor 32 for the interior 2.

In the method, it is checked and/or determined by the driver assistance system 36 for each sensorially detected object in and/or from the surroundings which of these is relevant for a respective current driving situation upon or during a journey for the ego vehicle, wherein furthermore a degree of a relevance of a respective object is ascertained and/or determined by the driver assistance system 36. The relevance is dependent here on at least one kinematic parameter of a respective object with respect to the ego vehicle, thus, for example, on a position and/or movement of the object relative to the ego vehicle. An object is all the more relevant, among other things, the shorter its distance to the ego vehicle is and/or if the distance between the object and the ego vehicle is decreasing.

It is determined here by the driver assistance system 36 which at least one object is to be marked. Information about this is transmitted from the driver assistance system 36 to the control device 34 for supervising, thus for controlling and/or regulating, the display system and the method. In consideration thereof, at least one light element on the windshield 10 is activated by the control device 34, which light element is assigned originating from the sensorially detected perspective and/or position of the head of the driver as the observer from the interior 2 through the at least one pane to the at least one detected object in the surroundings, wherein the at least one object is marked by the at least one activated light element.

The at least one light element which is to be activated and/or is activated is located here on an intersection point of a line of sight, which is sensorially detected and/or determined by the control device 34, for example, calculated, of the observer with the windshield 10. A first marking 26 is assigned here by first light elements to a first external vehicle 20 and a second marking 28 is assigned to the traffic signal as a road sign 24, since both objects are relevant for the driving situation. In contrast, no marking is assigned to a further external vehicle 22, since it is not relevant for the driving situation.

It is provided here by way of example that the ego vehicle is regulated by the driver assistance system 36 to the first external vehicle 20 driving in front here, wherein a distance to the external vehicle 20 and a speed of the ego vehicle to be designated as the set speed are maintained relative to the first external vehicle 20. It is provided that the driver assistance system 36 is active and/or is used here as an adaptable driver assistance (adaptive cruise assist, ACA). For this purpose, the first external vehicle 20 driving in front is marked green using the first marking 26. Further external vehicles in the surroundings are also detected, recognized, and/or determined by the at least one first sensor 30 and/or the driver assistance system 36, such as the second external vehicle 22, which is coming from the left in an intersection situation here. However, since it only will and/or could have influence on a turning behavior of the ego vehicle in a future driving situation, it is not yet marked in the current or instantaneous driving situation. At the same time, the traffic signal as a road sign 24 and its current switching to red is recognized, wherein the traffic signal is marked red using the second marking 28. If the traffic signal is switched to green, it is marked green. If it is switched to yellow, it is marked yellow. The traffic signal is accordingly marked in color in this case in accordance with the color displayed thereby and therefore its status.

In one embodiment, it can be checked using the method whether an object in the surroundings is recognized at all by the at least one first sensor 30, which is designed as a camera, for the surroundings and/or by the driver assistance system 36, whether it is correctly assigned with respect to its position in the surroundings, for example, by the driver assistance system 36, and whether its status and/or its relevance is or are correctly marked by color. In this case, for example, a red traffic signal can be marked red and a green traffic signal can be marked green. The first external vehicle 20 is marked green here, for example, as long as it drives in front of the ego vehicle. If the first external vehicle 20 is passed by the ego vehicle, it is automatically marked in another color due to a change of the driving situation.

In the event of the takeover request to the driver, when the initially at least semiautomatically or fully automatically controlled ego vehicle is to be manually controlled by the driver, the first external vehicle 20 driving in front is automatically marked red if the external vehicle 20 brakes abruptly and strongly, wherein the driver has to take over control and driving tasks proceeding from an at least semiautomatic journey. Upon passing, the external vehicle 20 is briefly marked in a neutral color, for example, white, in order to show that it is still recognized, but is no longer relevant.

Typically, all objects in the surroundings, at least further road users on a road traveled by the ego vehicle, to which the ego vehicle is regulated by the driver assistance system 36 and which are relevant for the current driving situation, are marked by selected light elements on the windshield 10. Depending on the driving situation, traffic signs adjacent to the road and further external vehicles 20, 22, for example, adjacent to the ego vehicle, can be marked in the method by light elements on the side pane 12 or behind the ego vehicle by light elements on the rear pane.

A distribution and/or density of the light-emitting diodes in the strip 14 is typically dependent on a design of the pane of the vehicle, designed here as the windshield 10, for example, for example on its size, in particular area, on its shape, on an angle at which it is inclined relative to a horizontal plane of the vehicle, and/or a type of the vehicle, for example, flat vehicle or tall vehicle. It is possible that individual light-emitting diodes have constant or variable distances in relation to one another in the horizontal direction and constant or variable distances in relation to one another in the vertical direction. Typically, the driver looks outward through the pane originating from his position on the driver seat. In this regard, a projection of the pane at a position of the head or the eyes of the driver perpendicular to the forward travel direction of the vehicle can be taken into consideration. The density and/or distribution of the light-emitting diodes and therefore of light elements on the pane, which can possibly be curved at least in some sections, is set here so that the distribution and/or density in the provided projection or a projection surface perpendicular to the forward travel direction is uniform and/or homogeneous. With a very steeply installed windshield, the light elements are distributed more uniformly. The flatter the windshield is, the more optimized the distance between the light elements has to be so that objects in or from the surroundings can be marked well on the pane.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

### REFERENCE SIGNS

2 interior
4 steering wheel
6 center console
8 A-pillar
10 windshield
12 side pane
14 strip
20, 22 external vehicle
24 road sign
26, 28 marking
30, 32 sensor
34 control device
36 driver assistance system

1. A display system for at least one pane of a window of an interior of a vehicle, the display system comprising:
light elements arrangeable on the at least one pane,
at least one control device, and
at least one sensor to detect at least one object in surroundings of the vehicle,
wherein the at least one control device is designed to activate at least one light element, among the light elements which are arranged on the at least one pane, which from a perspective of an observer from the interior of the vehicle through the at least one pane, is assigned to the at least one object that is detected in the surroundings,
wherein the at least one light element activated is designed to mark the at least one object.

2. The display system according to claim 1, wherein the light elements are arranged in at least one strip on the at least one pane.

3. The display system according to claim 1, wherein the light elements are designed as light-emitting diodes.

4. The display system according to claim 1, wherein the at least one control device exchanges data with at least one driver assistance system of the vehicle,
wherein the at least one driver assistance system is designed to assist a driver of the vehicle and to determine the at least one object to be marked from multiple objects in the surroundings.

5. The display system according claim 1, wherein the at least one pane of the vehicle is designed as a windshield.

6. A method of operating a display system for at least one pane of a window of an interior of a vehicle, the display system comprising:
light elements, arrangeable on the at least one pane,
at least one control device, and
at least one sensor to detect at least one object in surroundings of the vehicle,
wherein at least one light element, among the light elements which are arranged on the at least one pane, which from a perspective from the interior of the vehicle through the at least one pane, is assigned to the at least one object that is detected in the surroundings,
wherein the at least one light element is activated by the at least one control device, and the at least one object is marked by the at least one light element activated.

7. The method according to claim 6, in which it is checked by at least one driver assistance system which at least one object in the surroundings is relevant for a journey of the vehicle, wherein this at least one object is marked by the at least one light element.

8. The method according to claim 6, wherein at least a vehicle, a pedestrian, and/or a road sign, is marked as the at least one object using at least one color.

9. The method according to claim 6, wherein a symbol, which is assigned to the at least one object, is generated by the at least one light element.

10. The method according to claim 6, wherein at least one line of sight to the at least one object in the surroundings is determined from a head of an observer in the interior of the vehicle,
wherein at least one intersection point of the at least one line of sight with the at least one pane is determined, wherein the at least one light element is activated on the at least one intersection point.
